(19) United States
(12) Patent Application Publication
(10) Pub. No.: US 2010/0045116 A1
(43) Pub. Date: Feb. 25, 2010

(54) Method and Device for Detecting an Unexpected Disconnection of Connectors in a Circuit Carrying Electrical Current

(75) Inventors: Peter Morris, Rochester, NY (US); Vern P. Fleming, Rochester, NY (US)

Correspondence Address: BROWN & MICHAELS, PC;400 M & T BANK BUILDING, 118 NORTH TIOGA ST, ITHACA, NY, 14850, US

(73) Assignee: Integrated Safety Solutions, LLC, Rochester, NY (US)

(21) Appl. No.: 12/543,914

(22) Filed: Aug. 19, 2009

Related U.S. Application Data
(60) Provisional application No. 61/090,250, filed on Aug. 20, 2008.
(60) Provisional application No. 61/099,294, filed on Sep. 23, 2008.

(51) Int. Cl. H01H 35/00

(52) U.S. Cl. 307/116

(57) ABSTRACT

A device and method for detecting the imminent disconnection of electrical connectors before such an event occurs, thereby minimizing or eliminating the production of an electrical arc upon disconnection. The method detects the imminent disconnection of the connectors by use of a device located in the connector to signal the power source to cease sending electrical current through the connectors prior to the actual disconnecting event.

### REFERENCE TO RELATED APPLICATIONS

This application claims subject matter that was disclosed in Provisional Application No. 61/090,250, filed 20 Aug. 2008, and in Provisional Application No. 61/099,294, filed 23 Sep. 2008, both entitled “A Method and Device for Detecting an Unexpected Disconnection of Connectors in a Circuit Carrying Electrical Current”. Applicant hereby claims the benefit under 35 USC §119(e) of the U.S. provisional applications, and hereby incorporates the aforementioned applications by reference.

### FIELD OF THE INVENTION

The invention pertains to the field of electrical transmitting circuitry. More particularly, the invention pertains to connectors used to link segments of electrically conductive circuits. Specifically, the invention of a device and method by which current flowing through the connectors is rapidly terminated before any disconnection occurs.

### BACKGROUND OF THE INVENTION

Electrical circuits often carry tens of thousands of volts, especially in large industrial operations or within municipal electrical transmission lines. Since the circuits or electrical lines that carry the voltage are installed in a wide range of locations, it is necessary that they be made in a wide range of lengths. These different lengths are then connected to each other to an appropriate length by use of terminal connectors on each end of each cable.

Connecting and disconnecting the connectors is a serious operation and must be performed under carefully controlled conditions. If not done carefully, arcing may occur between one connector and the other during either connection or disconnection. These “arcs” of electricity can be extremely hazardous to equipment and personnel. An especially dangerous condition might exist if volatile solvents or gases are present in the area around the connectors. The size of the arc is influenced by factors such as circuit inductance, current (amperage), voltage and the speed of disconnection.

This invention is directed at preventing the production of such electrical arcs by anticipating the imminent disconnection and reducing the amount of current flowing through the connection should certain unexpected conditions begin to occur, such as an accidental disconnection.

### SUMMARY OF THE INVENTION

The present invention provides a device by which the imminent disconnection of at least one electrical connector is detected before such an event might occur. The output from such a device mounted to the connector is transmitted to a second device that substantially instantaneously terminates the current flowing through the connector(s) before disconnection occurs. The decay time for the source of the current may be so long that the reduction of the current to zero may not have been completed by the time the disconnection occurs. Nonetheless, even under these circumstances, the current will have been reduced substantially enough such that any arcing that does result is less than that which might have occurred under full current conditions, thus minimizing potentially catastrophic results from the electrical arc or the igniting of volatile gases that may be present around the connector(s).

### BRIEF DESCRIPTION OF THE DRAWINGS

FIG. 1 shows a block diagram of an electrical circuit from the power generating source, through the lines and connectors to the load, or end user of the electricity.

FIG. 2 is a detailed schematic of one embodiment of the electrical circuitry of the invention.

### DETAILED DESCRIPTION OF THE INVENTION

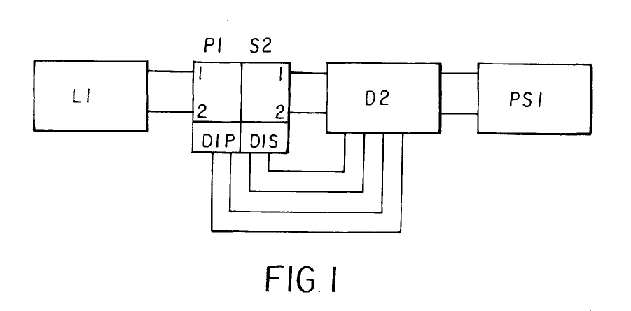

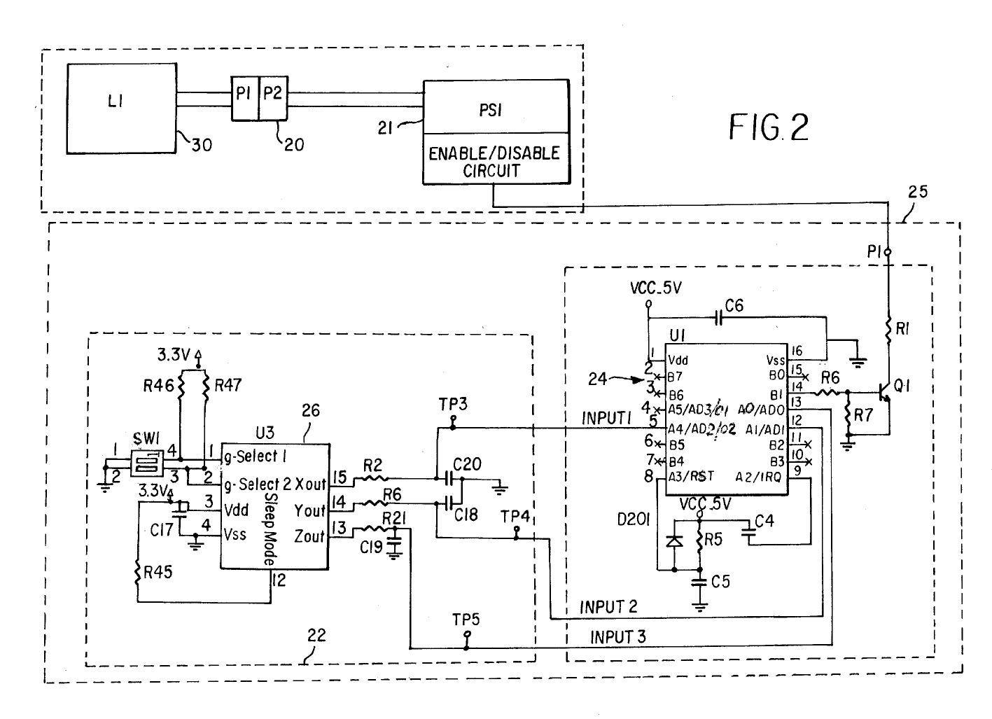

Referring to FIG. 1, a power generating source PSI (21 in FIG. 2) transmits electrical current through wires and an electrical control unit D2. D2 allows the current to flow to one of the connectors, generally indicated as 20 (FIG. 2), and in this example identified as a socket S2 which is non-permanently engaged with a plug, in this case designated as P1. The electrical current continues on to the load, or final end user, L1 30 (FIG. 2).

The invention consists of at least one detecting device, associated with each point of connection. In the example shown in FIG. 1, two detection devices are indicated. Detection device D1P is securely connected to plug P1 and detection device D1S is securely connected to socket S2. When either or both of the detectors D1P and D1S senses that the connectors are about to be disconnected, one or both of the detectors sends a signal to the electrical control unit D2, which substantially instantaneously signals the power source PS1 to cease current flow through this circuit. The result is that the current flowing through the connectors P1 and S2 is cut to zero or substantially zero to either prevent or substantially minimize the formation of an electrical arc upon connector disconnection. Note that as an alternative to switching off the power source, the load could be switched off.

The detectors D1P and D1S may consist of but are not limited to any of the following devices. These devices consist of accelerometers, strain gauges, thermal or optical sensors and electrical or capacitance measuring device. An accelerometer circuit 22 is shown schematically in FIG. 2.

Further embodiments of the present invention might include inserting the electrical control unit within the power generating source PSI. In another embodiment, the power source PSI (21) may be a battery charger and the load L1 (30) may be a battery. These embodiments are within the contemplation of the present invention.

Prior to disconnection, some movement of the connector housing occurs, with a large connector 20; many milliseconds may elapse before the electrical disconnection takes place. If the movement is detected, and the circuit can be switched off before the disconnection takes place, arcing can be substantially reduced or altogether eliminated.

An accelerometer 22 can be used to sense any movement in connector 20 and its electrical output fed to a detecting circuit, such as a microprocessor 24, which can switch off the power source.

One application for such an invention is any environment where an arc may be hazardous. For example, but not limited to, the gases emitted when a large battery is being charged. The invention also increases the lifetime of connectors since damage caused by arcing is reduced or eliminated.

Referring now to one embodiment of the invention shown in FIG. 2, an accelerometer 22 and detecting circuit 24, which is mounted in a housing 25, are fitted to the connector 20, which therefore moves with the connector 20. When movement is detected, the circuit transmits a signal via wires or wireless transmitter to a receiving circuit which switches off the power generating source 21 or other similar device prior to the actual unintentional disconnection of the connector 20.

U3 is the motion detecting integrated circuit 26 of accelerometer 22; the sensitivity is set by the state of the two-pole switch SW1. Since each section of the switch can be closed or open, the voltage applied to the g-Select 1 and g-Select 2 pins can be high or low. In binary terms, the options are 00, 01, 10, and 11. Each of the four states program U3 sensitivity. C17 provides filtering; R45 keeps U3 enabled whenever 3.3V is present.

U3 (26) provides a voltage output at the X Out, Y Out and Z Out pins which is proportional to the magnitude of the acceleration experienced by U3 in the X, Y and Z plane. Positive acceleration results in an increase in voltage; negative acceleration results in a reduction in voltage.

R2-C20, R6-C18 and R21-C19 filter out clock noise from the accelerometer output which might otherwise cause the detector 24 to give erratic results.

This embodiment of the invention uses a microprocessor U1 (24), but a comparator and timer components would work equally well. The X Out, Y Out and Z Out voltages from the accelerometer 22 are fed into three analog to digital inputs of the microprocessor. If the voltage levels on these inputs exceed a programmable high level internal reference or go below a programmable low level internal reference, pin B1 goes high, which turns on bipolar transistor Q1 and P1 (typically connected to 5V via a 1-10 k Ohm resistor) is taken low via the resistor, R1. This level change can in turn be used to disable the electrical power source 21 before the physical disconnection of the connector occurs.

Since in most cases the connectors would lie in one plane, if the sensitivity of the U3 (26) is set to a level where 1 g or less produces an output voltage which causes the microprocessor to give a high voltage output on pin B1 within detector 24, the electrical source will be disabled under static conditions. To avoid this problem, the output from the microprocessor is pulsed, the output occurs only for a defined time after which the output from B1 returns low and no further output will result from acceleration with this polarity in this plane. Acceleration of the opposite polarity or output resulting from the other two planes will however still produce an output pulse. After a reasonable amount of time, the circuit can be tested to see if a load is present. If no load is present, the source remains off; if a load is present the source can be re-enabled. Alternatively the output from this circuit could be ignored at initial power up.

C6 filters out electrical noise from the 5V supply to prevent it disturbing U1. The network consisting of D201, R5 and C5 resets the microprocessor on power up. C4 improves noise immunity. R6 and R7 modify the output from the microprocessor to match Q1. The resistor R1 limits the current that flows to ground if connected to a capacitive load when Q1 changes to the on state.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A device which is mounted on a current carrier between a power source and a load comprising at least one connector which can detect the imminent disconnection of at least one connector in order to switch off the power source or the load prior to the disconnection occurring thereby preventing an arc if current is still flowing between the power source and the load.

2. The device of claim 1 wherein a sensor is used to detect the imminent disconnection, the sensor being selected from the group consisting of an accelerometer, a strain gauge, a thermal sensor, an optical sensor, an electrical detector and a capacitance measuring device.

3. The device of claim 2 wherein the sensor is an accelerometer.

4. The device of claim 1 wherein the load is an end user of the electrical current.

5. The device of claim 1 wherein the connector provides an electrical connection between an electrical power source that provides an electrical current to the end user of the electrical current.

6. The device of claim 1 wherein the detector is operably engaged with a microprocessor.

7. The device of claim 6 wherein the microprocessor is able to detect a change in the output of the sensor which is indicative of an impending disconnection of the connector.

8. The device of claim 1 wherein the detector is adjustable to detect variable degrees of change in the output of the sensor.

9. The device of claim 8 wherein the detector provides a pulsed output.

10. The device of claim 1 further comprising means for monitoring the load so that current flow can be restored if the load is reconnected.

11. A method for preventing or substantially reducing an electrical arc from occurring upon the disconnection of an electrical connector carrying current by the use of a device which is mounted on at least one current carrying connector which can detect the imminent disconnection of at least one connector and switch off a power source or the load prior to the disconnection occurring wherein the device has a sensor followed by a detector, the method comprising the steps of:
a) providing electrical current from a power source to a first section of the connector;
b) conducting the electrical current from the first section to a second section of the connector;
c) the sensor measuring movement or human contact which may indicate the impending disconnection of the electrical connector; and
d) the detector sending a signal to the power source to terminate sending the electrical current through the connector.

12. The method of claim 11 wherein the detector is selected from the group consisting of an accelerometer, a strain gauge, a thermal sensor, an optical sensor, an electrical detector and a capacitance measuring device.

13. The method of claim 12 wherein the detector is an accelerometer.

14. The method of claim 11 wherein the detector is operably engaged with a microprocessor.

15. The device of claim 14 wherein the microprocessor is able to detect a change in the output of the sensing circuit which is indicative of an impending disconnection of the connector.

16. The device of claim 1 wherein the detector is adjustable to detect variable degrees of change in the output of the sensing circuit.

17. The device of claim 16 wherein the detector provides a pulsed output.

18. The device of claim 11 with means of monitoring the load so that current flow can be restored if the load is reconnected.
